(19) United States
(12) Patent Application Publication
(10) Pub. No.: US 2017/0245489 A1
(43) Pub. Date: Aug. 31, 2017

(54) A TRAP FOR CATCHING OF SMALL ANIMALS LIKE RATS AND MINKS

(71) Applicant: GH TRAP TEKNIK SWEDEN AB, Linneryd (SE)

(72) Inventor: Göran HANSSON, Linneryd (SE)

(73) Assignee: GH TRAP TEKNIK SWEDEN AB, Linneryd (SE)

(21) Appl. No.: 15/510,207

(22) PCT Filed: Apr. 28, 2016
(86) PCT No.: PCT/SE2016/000021

§ 371 Date: Mar. 9, 2017

(30) Foreign Application Priority Data
Apr. 29, 2015 (SE) 1500209-0

(51) Int. Cl. A01M 23/30; A01M 31/00

(52) U.S. Cl. CPC A01M 23/30; A01M 31/008

(57) ABSTRACT

A trap for catching small animals includes a stand and a clamp journaled therein, which form an adapted first position may be brought to swing to a second position, killing the animal by lifting of a cap above a container by the animal. The trap is especially designed such that the cap has to be turned upwards by such an angle α, that an animal reaches a bait. This angle α is suitably about 25 degrees.

The present invention relates to a trap for catching of small animals like rats and minks, but also mice and forms a substantial development of a trap according to the Swedish patent SE 9502253 from 1995-06-21. The shape of this trap is clear from the enclosed 1:st patent claim, and its limitation is, that it can only be used for small animals like mice. There is, however, a need for traps for larger animals than these, like rats and minks.

A trap of the shape defined by the first part of the 1:st patent claim is thus so formed, that the supporting surface of the arm portion against the first arm of the clamp means has such a length and the tap is such designed, that the same cannot releasing reach the first before the cap has been turned upwards such an angle α, that an animal can reach a bait.

Other characteristics of the trap according to the invention are obvious from the subclaims.

The invention is disclosed in the following, reference being made to the enclosed schematic figures, in which

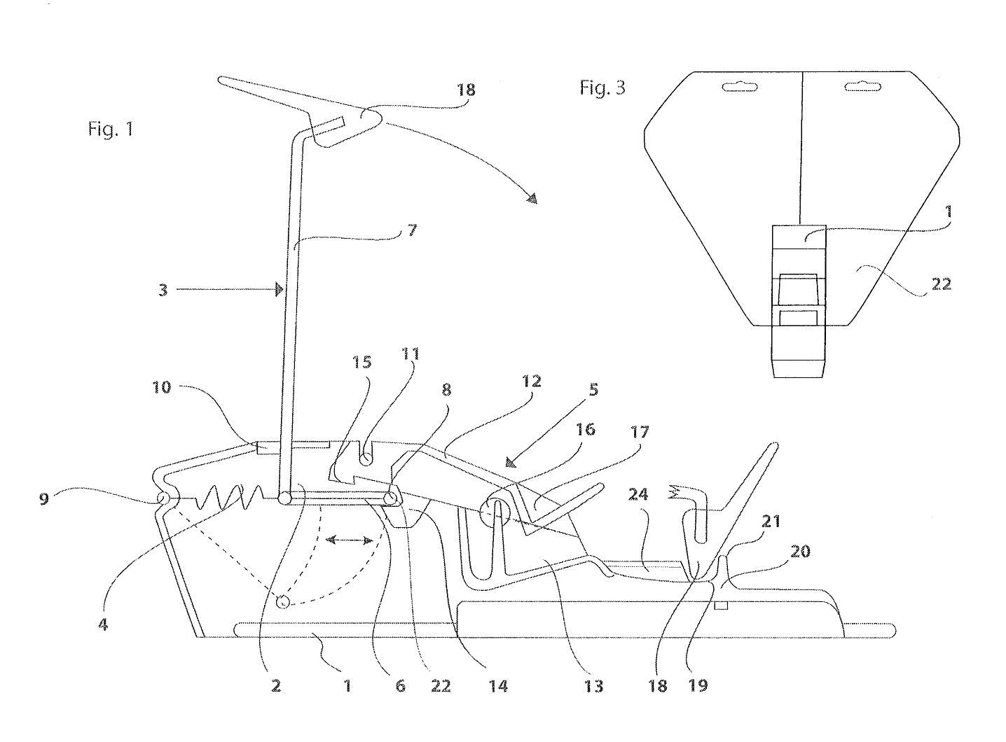

FIG. 1 shows a side view of a trap partly in section,

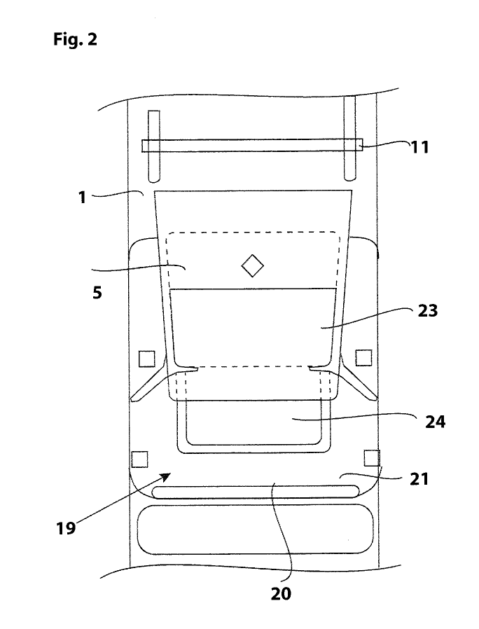

FIG. 2 shows a view from above of a portion of the trap,

FIG. 3 shows a view from above of the trap at an underlying mat,

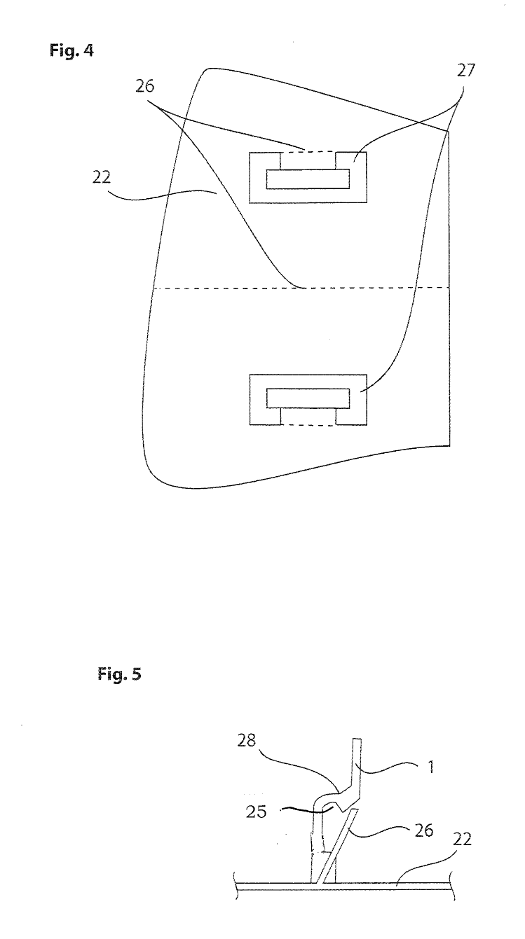

FIG. 4 shows a view of a mat with T-formed fastening means cut from it,

FIG. 5 shows, in a square section, a T-formed fastening means, ready to get into a fastening position.

In the figure a stand is marked by 1, a first axis by 2, around which a clamp means 3 is journalled, swingable, against a screw spring 4, stretchable to a first, adapted position. The clamp means is provided with, extending from the first axis 2, a first arm 6 and a second arm 7. The end of the first arm 6, directed from the first axis 2 forms a fastening point 8 for a force means in the form of a screw spring, whereas the second fastening point 9 is located at the stand 1. In the first, adapted position of the clamp means 3 the force of the screw spring 4 runs through the first axis 2, such that there is no turning momentum at the clamp means 3.

A stop means 10 is provided in order to prevent the clamp means 3 to be turned anti-clockwise. A releasing means 5 is journalled around a second axis 11 at the stand, and shows a first arm portion in the form of a cap 12 above a container 13 for a bait and a second arm portion 14, which in the form of a stop means locks the first arm 6 of the clamp means 3 when this is in its first position. The releasing means 5 is provided with a third portion in the form of a tap 15, which can releasing press against the first arm 6 of the clamp means 3. The supporting surface 22 of the arm portion 14 against the first arm 6 of the clamp means has such a length, and the tap 15 is such formed, that the same does not releasing reach the first arm 6, until the cap 12 has been turned upwards such an angle α, that an animal can reach a bait. The angle α is about 25 degrees.

In one advantageous form of the trap the releasing means in the form of a cap 12 is such journalled around the second axis 11 that its displacement horizontally is prevented.

From the bottom of the container 13 there extends a pillar directed upwards with a narrow end 16 for fastening of a bait.

The cap 12 is at its free end formed, seen in a square section, as a V-formed portion 17, open upwards, the outer portion of which is intended to determine the successive opening of the cap 12 by the animal. The pillar with the narrow end 16 and the V-formed portion 17 have such dimensions, that the animal must press up the cap in order to reach the bait at the narrow end 16.

The cap 12 may, at the upper side be formed like a bowl, open upwards, for placing of a tempting bait. In a suitable design the V-formed portion of the cap is provided with side walls, such that a bowl is formed. One further bowl 24 may be provided at the inside of strangling threshold 20. These bowls have the advantage, that more or less fluent bait may be used to tempt animals to be catched. Any change of the bait in an open bowl indicates if an animal has been present at the trap.

The clamp means is at its fee end formed with a hit portion 18 and the stand 1 is formed with an anvil 19 against which said hit portion 18 strikes in the second, crushing, killing position of the clamp means 3. A strangling threshold 20 is provided outside of the anvil 19 with upwards enlarged side supports 21 at each side of the strangling threshold 20.

In one suitable embodiment the trap is releasably fastened to a mat 22 below. This combination has the advantage, that the animal cannot draw away the trap after having been trapped.

The releasable fastening of the trap at the mat may be arranged in many ways for example by bands or hooks. In one advantageous design, in the case the mat 22 is made from relatively stiff plastic, two T-formed fastening elements 27 are cut from the mat 22 turned around axes 26. Their planes are parallel to the length direction of the trap at such a distance from each other, that they from inside may be folded upwards to each its inner wall of the stand 1 formed as each its longitudinal profile 28 with openings 25 directed downwards, wherein resp edge of the T-portions of the fastening means may be locking fastened.

1. A trap for catching small animals, comprising:
a stand;
a pivoting clamp journaled around a first axis, which clamp can be strained against the action of a force mechanism to a first loaded position and can be released from the first loaded position by a release in the form of a cap, when an animal acts upon the same and under influence of the force mechanism substantially immediately swings to a second position, killing hitting the animal, the clamp, extending from the first axis being provided with a first and a second arm, whereas the end of the first arm turned from the first axis forms a first fastening point of said force mechanism, the second fastening point of which is at the stand, whereas the force between the fastening points in the first position of the clamp runs through the first axis, whereas a stop is provided to secure, that the clamp in the adapted position is not prevented from swinging to the second position, whereas the release is journaled around a second axis in the stand and is provided with a first arm portion formed like a cap above a container for a bait and is provided with a second arm portion, which in the form of a securing member locks the first arm of the clamp when this is in its first position, whereas the is provided with a third portion in the form of a tap which releasing may press against the first arm of the clamp,
wherein the supporting surface of the arm portion against the first arm of the clamp has such a length and the tap is such designed, that the same cannot releasing reach the first arm until the cap has been turned upwards such an angle α, that an animal can reach the bait.

2. The trap according to claim 1, wherein-the angle α is about 25 degrees.

3. The trap according to claim 1, wherein there is a pillar with a narrow end extending from the inner wall of the container for fastening of the bait.

4. The trap according to claim 1, wherein the cap at its free end is formed, seen in a square section, as a V-formed portion, open upwards, the outer portion of which is intended to determine the successive opening of the cap by the animal.

5. The trap according to claim 3, wherein the narrow end and the V-formed portion have such dimensions, that the animal must press up the cap in order to reach the bait at the narrow end.

6. The trap according to claim 1 wherein the cap at the upper side is formed like a bowl, open upwards.

7. The trap according to claim 6, wherein the V-formed portion of the cap is provided with side walls, such that a bowl for outer bait is formed.

8. The trap according to claim 1, wherein the release in the form of a cap is so designed, journaled around the second axis, that its displacement horizontally is prevented.

9. The trap according to claim 1, wherein the clamp at its fee end is formed with a hit portion, whereas the stand is formed with an anvil against which said hit portion strikes in the second, crushing, killing position of the clamp, whereas a strangling threshold is provided outside of the anvil with upwards enlarged side supports at each side of the strangling threshold.

10. The trap according to claim 1, wherein the trap is releasably fastened to a mat below.

11. The trap according to claim 10, wherein the mat is made from relatively stiff plastic, whereas two T-formed fastening elements are cut from the mat turned around axes, with their planes parallel to the length direction of the trap at such a distance from each other, that they from inside upwards to each inner wall of the stand formed as each longitudinal profile with openings wherein a respective edge of the T-portions of the fastening elements may be locking fastened.

12. The trap according to claim 2, wherein there is a pillar with a narrow end extending from the inner wall of a bottom of the container for fastening of the bait.

13. The trap according to claim 2, wherein there is a pillar with a narrow end extending from the inner wall of the container for fastening of the bait.

14. The trap according to claim 2, wherein the cap at its free end is formed, seen in a square section, as a V-formed portion, open upwards, the outer portion of which is intended to determine the successive opening of the cap by the animal.

15. The trap according to claim 3, wherein the cap at its free end is formed, seen in a square section, as a V-formed portion, open upwards, the outer portion of which is intended to determine the successive opening of the cap by the animal.

16. The trap according to claim 4, wherein the cap at its free end is formed, seen in a square section, as a V-formed portion, open upwards, the outer portion of which is intended to determine the successive opening of the cap by the animal.

17. The trap according to claim 4, wherein the narrow end and the V-formed portion have such dimensions, that the animal must press up the cap in order to reach the bait at the narrow end.

18. The trap according to claim 2, wherein the cap at the upper side is formed like a bowl, open upwards.

19. The trap according to claim 3, wherein the cap at the upper side is formed like a bowl, open upwards.

20. A trap according to claim 4, wherein the cap at the upper side is formed like a bowl, open upwards.
